(19) United States
(12) Patent Application Publication
(10) Pub. No.: US 2016/0147957 A1
(43) Pub. Date: May 26, 2016

(54) System and Method for a Healthcare Provider

(71) Applicants: Maryrose Reaston, Carlsbad, CA (US); Phil Reaston, Carlsbad, CA (US)

(72) Inventors: Maryrose Reaston, Carlsbad, CA (US); Phil Reaston, Carlsbad, CA (US)

(21) Appl. No.: 14/551,937

(22) Filed: Nov. 24, 2014

(51) Int. Cl. G06F 19/00; G06Q 30/00

(52) U.S. Cl. CPC G06F 19/345; G06Q 30/018; G06F 19/3406

(57) ABSTRACT

A system and method for a healthcare provider that facilitates the creation of baseline test data and post-loss test data to determine if an individual has experienced a legitimate work-related injury. Additionally, the HP (10) employs or retains the services of healthcare professionals (18) who provide general injury assessment. The HP (10) provides a medical diagnostic unit, which is known as an EFA, that utilizes electromyography (EMG), range-of-motion (ROM) and functional capacity assessment (FCA). The EFA receives data that pertains to an individual via a real-time communication protocol (28), or the individual's data is collected and stored on an electronic storage device (30).

This application is a continuation-in-part of application Ser. No. 13/487,562 with a filing date of Jun. 4, 2012.

### TECHNICAL FIELD

The invention generally pertains to healthcare organizations, and more particularly to a healthcare provider that provides medical services and utilizes a proprietary medical diagnostic unit which facilitates the creation of baseline test data and post-loss test data to determine if an individual has experienced a legitimate work-related injury or change in medical condition.

### BACKGROUND ART

One of the most significant problems in the United States today is the number of fraudulent workers-compensation injury claims that are made. It is often difficult to prove if an individual was truly injured at work, and many fraudulent claims are deemed legitimate, therefore costing employers and the United States Government a large amount of money.

A solution to this problem is clearly needed. An effective solution would create a set of tests that produce baseline test data for newly-hired or existing employees. In the event one (or more) of the employees claims a work-related injury has occurred, a second set of tests are performed, creating post-loss test data. The baseline data, which is only read/analyzed in the event of an injury, is then compared to the post-loss data to determine, if there is a change in an individual's condition which would indicate whether an injury is legitimate or not.

Also, with the advent of highly sophisticated medical devices, and the portability of such devices, healthcare delivery has become global. Global healthcare, aka global medicine, is primarily characterized by a doctor being at one location, and a patient being at another location. The distance between doctor and patient can be minimal, such as the doctor in one room and the patient in an adjoining room, or the distance can be significant, such as the doctor and patient each being on opposite sides of the earth.

The benefits of a global healthcare provider are obvious. In the past, if a person in a remote location was injured or became ill, there could often be a delay of days or weeks before the person was brought to a doctor or medical facility. If the injury or illness was serious, the delay often resulted in the death of the person. Now it is possible to provide instant state-of-the-art medical care to the most remote location, thereby substantially increasing an injured or sick person's change of recovery or survival.

Additionally, many people have a personal doctor whom they trust and feel comfortable with a global healthcare provider will allow an individual to continue their relationship with a preferred doctor even if the individual or the doctor relocates.

A search of the prior art did not disclose literature or patents that read directly on the claims of the instant invention. However, the following U.S. patents are considered related:

| PATENT NO. | INVENTOR | ISSUED |
|---|---|---|
| 8,117,047 | Cusimano-Reaston | 14 Feb. 2012 |
| Aetna Publication No. | Chang et al | Pub. Date: |
| US2011/0092779 | | Apr. 21, 2011 |
| Clinical Policy Bulletin: Physical | | Oct. 7, 2011 |
| Therapy Services No. 0325 | | |

The U.S. Pat. No. 8,117,047 patent discloses a business model for a healthcare provider organization (HPO) which comprises a preferred provider network (PPO) or other membership agreement that allows individuals or groups to join via a membership contract. The contract allows the HPO to provide a technical component of a medical evaluation or service. Additionally, the HPO employs or retains the services of healthcare professionals who participate in and monitor an evaluation of a patient who can be at a remote location from the healthcare professional. The HPO provides a medical diagnostic unit that allows the healthcare professional to receive data that pertains to the patient via a real-time communication protocol, or the patient data is collected and stored on an electronic storage device. The healthcare professional then analyzes the patient data and issues recommended treatment.

The publication no. US2011/0092779 issued to Chang et al discloses devices, systems and methods which relate to monitoring the health of an individual. The individual wear a health monitoring device capable of sensing characteristics of the individual. These characteristics may include voice level and tone, movements, blood pressure, temperature, etc. The device allows individuals to constantly monitor their health without having to physically visit a doctor or other health care professional. Wireless communication allows measurements to be made and evaluated by a “computerized” healthcare service provider. The device communicates with services in order to diagnose the individual based upon the characteristics. Chang's application is for an individual to monitor their health. The Applicant's invention discloses a system and method for medical providers and remote monitoring and pertains to an EFA. In Chang the device can also communicate over the internet for diagnosis, but does not perform a combination of EMG, ROM, FCA, to create baseline test data and post-loss test data which is the subject of the Applicant's invention.

The Aetna Clinical Policy Bulletin discloses that Aetna considers physical therapy medically necessary when this care is prescribed by a physician in order to significantly improve, develop or restore physical functions lost or impaired as a result of a disease, injury or surgical procedure. Once therapeutic benefit has been achieve, or a home exercise program could be used for further gains, continuing supervised in asymptomatic persons or without an identifiable clinical condition is considered not medically necessary. Physical therapy in persons whose condition is neither regressing nor improving is considered not medically necessary.

For background purposes and as indicative of the art to which the invention relates, reference may be made to the following remaining patents found in the search:

| PATENT NO. | INVENTOR | ISSUED |
|---|---|---|
| 5,163,440 | DeLuca et al | November 1992 |
| 5,361,775 | Remes et al | November 1994 |
| 5,368,043 | Sunouchi et al | November 1994 |
| 5,462,065 | Cusimano | October 1995 |
| 5,513,651 | Cusimano et al | May 1996 |
| 5,585,785 | Gwin et al | December 1996 |
| 5,662,118 | Skubick | September 1997 |
| 5,722,420 | Lee | March 1998 |
| 5,784,635 | McCallum | July 1998 |
| 5,785,666 | Costello et al | July 1998 |
| 5,919,148 | Marko et al | July 1999 |
| 5,964,719 | Costello et al | October 1999 |
| 6,004,312 | Finneran et al | December 1999 |
| 6,159,147 | Lichter et al | December 2000 |
| 6,185,451 | Richardson et al | February 2001 |
| 6,265,978 | Atlas | July 2001 |
| 6,280,395 | Appel et al | August 2001 |
| 6,322,502 | Schoenberg et al | November 2001 |
| 6,352,516 | Pozos et al | March 2002 |
| 6,440,067 | DeLuca et al | August 2002 |
| 6,441,747 | Khair et al | August 2002 |
| 6,493,578 | DeFeo | December 2002 |
| 6,496,705 | Ng et al | December 2002 |
| 6,575,902 | Burton | June 2003 |
| 6,597,944 | Hadas | July 2003 |
| 6,631,297 | Mo | October 2003 |
| 6,643,541 | Mok et al | November 2003 |
| 6,647,288 | Madill et al | November 2003 |
| 6,678,549 | Cusimano et al | May 2004 |
| 6,738,798 | Ploetz et al | May 2004 |
| 6,745,062 | Finneran et al | June 2004 |
| 6,816,603 | David et al | November 2004 |
| 6,856,833 | Finneran et al | February 2005 |
| 6,915,148 | Finneran et al | July 2005 |
| 6,917,825 | Finneran et al | July 2005 |
| 6,917,829 | Kwong | July 2005 |
| 6,965,794 | Brody | November 2005 |
| 7,020,508 | Stivoric et al | March 2006 |
| 7,027,621 | Prokoski | April 2006 |
| 7,058,438 | Grace et al | June 2006 |
| 7,110,809 | Nakada | September 2006 |
| 7,127,279 | Finneran et al | October 2006 |
| 7,130,673 | Tolvanen-Laakso et al | October 2006 |
| 7,150,715 | Collura et al | December 2006 |
| 7,160,253 | Nissila | January 2007 |
| 7,188,151 | Kumar et al | March 2007 |
| 7,313,957 | Kuramori et al | January 2008 |
| 7,363,069 | Finneran et al | April 2008 |
| 7,381,185 | Zhirnov et al | June 2008 |
| 7,409,242 | Mackawa et al | August 2008 |
| 7,421,293 | Kuramori et al | September 2008 |
| 7,433,733 | Endo et al | October 2008 |
| 7,467,010 | Kuramori et al | December 2008 |
| 7,486,987 | Kuramori et al | February 2009 |
| 7,493,157 | Gozani et al | February 2009 |
| 7,574,369 | Borza | August 2009 |
| 7,602,301 | Stirling et al | October 2009 |
| 7,627,358 | Finneran et al | December 2009 |
| 7,628,761 | Gozani et al | December 2009 |
| 7,634,315 | Cholette | December 2009 |
| 7,649,445 | Kuramori et al | January 2010 |
| 7,693,572 | Kuramori et al | April 2010 |
| 7,725,175 | Koeneman et al | May 2010 |
| 7,764,990 | Martikka et al | July 2010 |
| 7,767,149 | Maus et al | August 2010 |
| 7,809,435 | Ettare et al | October 2010 |
| 7,831,302 | Thomas | November 2010 |
| 7,860,562 | Endo et al | December 2010 |

### DISCLOSURE OF THE INVENTION

A system and method for a healthcare provider to provide baseline test that is based on some of the essential functions of an individual's job that is Americans with Disability Act (ADA), compliant that compares to a post-loss test on the individual and injured body part, and performs a technical component of a medical assessment by use of an electrodiagnostic functional assessment unit (EFA).

The technical component preferably consists of a testing protocol that determines if an individual who is claiming to have been injured at work has experienced a legitimate work-related injury. The testing protocols are methods which are comprised of a series of steps that create baseline test data and post-loss test data which is compared and analyzed after an individual makes an injury claim. The data, which is based on electromyography (EMG), range-of-motion (ROM), and functional capacity assessment (FCA), determines if there is a change in the individual's condition from the baseline test to the post-loss test. The baseline test data, which is not read or analyzed until an individual makes an injury claim, is created either for an existing employee or a newly-hired employee. The baseline test data is created for each employee and is created based on their specific job functions. The post-loss test data is created and taken after an individual has experienced an injury. The post-loss data is created based on the type of injury the individual is claiming to have experienced and on the job and alleged body part that is injured. By comparing and analyzing the baseline data with the post-loss data, it can be determined if the individual has experience a legitimate injury that occurred while working.

In addition, the system and method also provides general injury assessment by use of the EFA, the EMG, ROM and FCA data. When the EFA diagnostic unit is located at a remote location from the healthcare professional, the HP can train and provide medical assistants to perform the EFA diagnostic testing on a patient. The medical assistants can be registered nurses, licensed vocational nurses, medical assistant, exercise physiologists or other health or allied health providers.

In view of the above disclosure, the primary object of the invention is to provide a system and method for a healthcare provider that utilizes a diagnostic unit to determine if an individual has legitimately experienced a work-related injury and to provide on-site or remote medical monitoring, testing and injury assessment of an individual based on the individual's own data and job, and the baseline is not analyzed until an injury occurs, therefore it complies with applicable laws and does not cause discrimination.

In addition to the primary object of the invention, it is also an object of the invention to provide a business model for a healthcare provider organization that:
does not violate franchise or healthcare laws,
is United States Occupational Safety and Health Administration compliant,
is ADA compliant,
installs all necessary equipment, and conducts assessments,
markets/advertises the healthcare providers services to potential clients and patients,
selects the tests/evaluations that are performed on each particular patient,
chooses the most appropriate healthcare professional to assess a patient, and
allows the healthcare professional to participate in the technical component of the assessment.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram of a healthcare provider.

FIG. 2 is a block diagram showing the steps of the method.

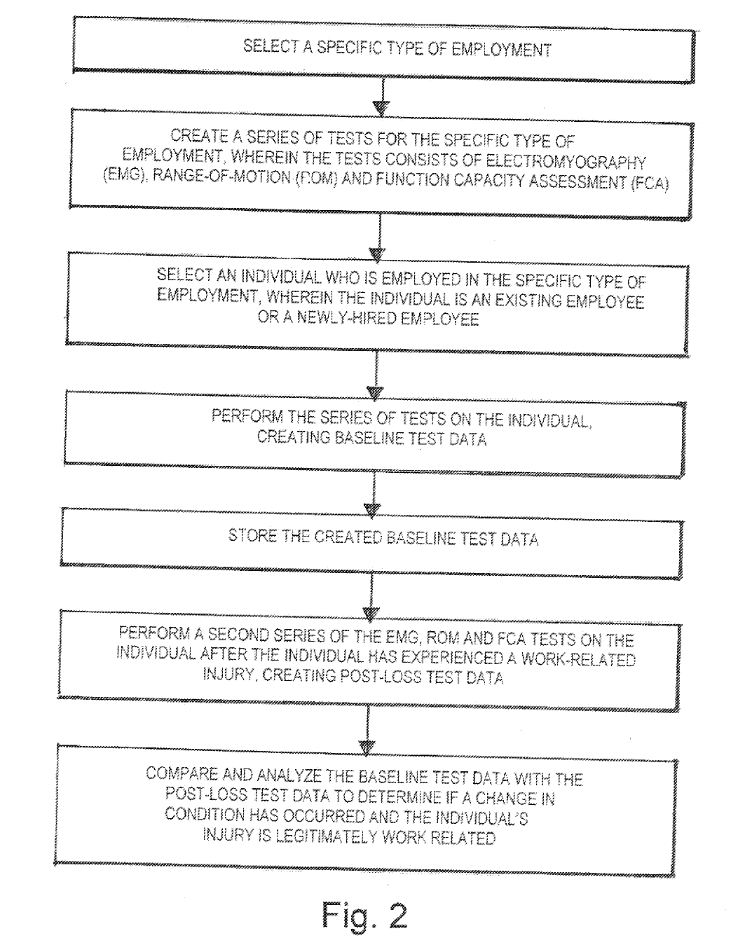

### BEST MODE FOR CARRYING OUT THE INVENTION

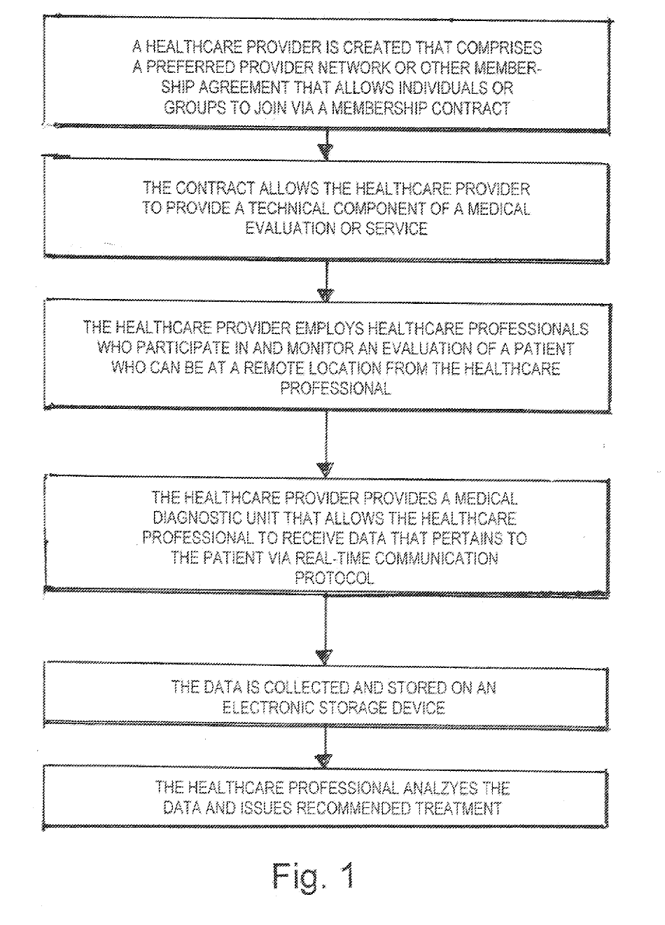

The best mode for carrying out the invention is presented in terms of a preferred embodiment of a system and method for a healthcare provider 10, (hereinafter “HP 10”). As shown in FIG. 1, the HP is comprised of a preferred provider network (PPO) or other membership agreement that allows individuals or groups to join via a membership contract 14. The primary function of the contract 14 is to allow the HP 10 to provide a technical component of a medical evaluation 16.

Preferably, the technical component consists of a testing protocol that determines if an individual who is claiming to have been injured at work has experienced a legitimate work-related injury. The testing protocol is the method which is comprised of a series of steps that create baseline data and post-loss data which is compared and analyzed after an individual makes an injury claim. The baseline test steps and/or the post-loss test steps do not have to be performed by the same, single healthcare provider, so the respective steps can be individually performed based on the functional requirement(s). It is important to note, that the system and method disclosed herein is not an abstract idea and therefore overcomes any objection(s) based on the U.S. Supreme Court ruling of Alice Corporation vs. CLS Bank International. The instant system and method provide “concrete” steps that, while the method does utilize a computer operating proprietary software, also utilizes and has implemented non-software based testing and analysis, therefore refitting any comparison to a strictly abstract idea.

The HP 10 provides a medical diagnostic unit 24 that allows the healthcare professional 18 to receive data that pertains to the patient 20 via a rear-time communication protocol 26. The medical diagnostic unit 24 is comprised of an Electro Diagnostic Functional Assessment (EFA) Unit which is disclosed in U.S. patent application Ser. No. 11/647,361. For the primary purpose of this system and method, the EFA is utilized to perform baseline testing and post-loss testing.

The EFA based tests are non-invasive, non-loading, and are designed for an individual's specific job and certain essential functions. The baseline data, which is stored and only analyzed if there is an injury, is used to compare an individual's condition to him/herself in a limited scope on a post injury.

The baseline testing is used only for claims that arise out of the course and scope of employment (AOECOE). If a work-related claim is not AOECOE and can be provided by objective medical evidence such as a pre- and post-assessment and there is no charge from the baseline, then there is no workers' compensation claim and no mandatory reporting issue. A proven example of a baseline test for musculoskeletal disorders (MSD) cases is the EFA-Soft Tissue Management program which begins by providing baseline injury testing on existing employees and newly-hired employees. The data is only interpreted when and if there is a soft tissue injury claim. After a claim, the injured worker is required to undergo the post-loss testing. The subsequent comparison objectively demonstrates whether or not an acute injury exists. If there is an injury, site specific treatment recommendations are made for the AOECOE condition, ensuring that the injured worker receives the best care possible.

The method is comprised of the following steps:

1) select a specific type of employment,

2) create a series of tests for the specific type of employment wherein the tests consist of electromyography (EMG), range-of-motion (ROM) and functional capacity assessment (FCA),

3) select an individual or all individuals who are employed in the specific type of employment, wherein the individual(s) are existing employee(s) or a newly-hired employee(s),

4) perform the series of tests on the individual, creating baseline test data,

5) upload baseline test data encrypted,

6) store the created baseline test data,

7) perform a second series of the EMO, ROM and FCA tests on the individual after the individual has experienced a work-related injury, creating post-loss test data that is based on the baseline data and individual's body part that is injured, and

8) compare and analyze the baseline test data with the post-loss test data to determine if a change in condition has occurred and the individual's injury is legitimately work related.

The above steps are especially effective when an individual has filed a workers-compensation claim or other type of legal claim. During these types of scenarios, as well as others, there are legal guidelines that must be followed. In order to facilitate the legal obligations and to provide complete objectivity, the baseline test data is never read or analyzed until an individual files an injury claim and undergoes the secondary tests which provide the post-loss test data; only then is the baseline data compared to the post-loss data. Additionally, the baseline data that is analyzed and compared is selected, when possible, based on the specific injury that the individual is claiming he/she experienced. The combined measures taken when utilizing the baseline data, makes the method U.S. Americans with Disability (ADA) and U.S. Occupational Safety and Health Administration (OSHA) compliant.

In addition to the above disclosed method of determining if an individual has experienced a legitimate work-related injury, the method and system also can provide general injury assessment and compare it as part of a wellness assessment to specific body conditions. The assessment data can be retained in case an individual's develops a condition at a later data that needs to be traced or monitored.

The injury assessment can be performed on a human or animal body, including cervical, cranial, thoracic, lumbosacral, as well as upper and lower extremities. Specially designed electrodes are used to monitor cardiac function. The EFA also combines a load cell and two strain gauges to determine a subject's lifting, pushing, pulling, gripping and pinching capabilities with range of motion ability. The EFA functions in tandem with an integrated medical grade computer running a proprietary software program, which correlates muscle activity with range of motion, cardiac activity, temperature, lifting, pushing, pulling, gripping and pinching.

The design of the EFA allows for electromyograph (EMG), range of motion (ROM) (spinal, upper and lower extremities, and hip and digits), grip assessment, pinch assessment, functional assessment, cardiac assessment, temperature assessment and nerve conduction studies to be conducted during a single testing session. The EFA also allows for monitoring of cardiac, blood flow, heart rate, nerve conduction, EEG, as well as remote monitoring. In addition, the advantage of the EFA is that it combines all physiological monitoring for diagnostic purposes with site specific treatment modalities. This is accomplished by integrating the electrical stimulation, ultrasound capabilities and/or massage of the EFA.

As disclosed above, the EFA is utilized to perform the medical evaluation or service 16. Depending on the relationship between the HP 10 and the healthcare professional 18, (i.e., if the healthcare professional 18 in a member of the HP 10), the EFA unit is either purchased by the healthcare professional 18, rented or leased by the healthcare professional, or given to the healthcare professional 18. If the healthcare professional 18 becomes a member of the HP 10 (or the PPO), the EFA unit is a supplied element of the membership contract 14. The most significant benefit of utilizing the EFA is that it can be at a remote location from the healthcare professional 18. The actual distance that the EFA, and therefore the patient, can be located away are vary from minimal, such as the patient and healthcare professional in adjoining rooms, or substantial, such as the patient located on a different continent. This provides tremendous benefits, such as allowing people who live in under-developed or remote areas of the world to quickly and easily receive state-of-the-art medical attention. Some additional benefits are:

1) a person can consult and be treated by their personal physician regardless of where they arc. This is important for people who travel or people who have moved to a new location but have an established relationship with a particular physician.

2) an EFA unit can be placed at a location that facilitates its use for specialized injuries, such as sports injuries and medicine, and

3) an EPA unit can be placed in a mobile environment, such as an airplane, train, subway, city bus, etc. In some respects, this would be the equivalent of having a physician present in any mobile environment, thereby providing immediate emergency medical attention to travelers. An EFA unit could even be placed in ambulances as an addition to the current medical communication systems that are in use. The location when the EFA is placed is usually selected by the I-IP 10, especially when the healthcare professional 18 who is using the EFA is a member of the HP 10.

Typically, when the EFA unit is located in a remote location, a medical assistant 26 will be present to assist in preparing a patient for evaluation and to operate the EFA. Preferably, the medical assistant 26 will be a registered nurse, but additionally, other medical assistants such as a licensed vocational nurse, general medical assistant, exercise physiologist, or other health or allied health professionals can be employed.

Once a patient 20 has been evaluated by the EFA's testing protocols, the patient's data is sent to the healthcare professional 18. The data is sent via a communication protocol 28 that is preferably comprised of a secure, encrypted Internet connection. Additionally, a secure dedicated phone line, such as an ISDN line, can also be utilized.

If for some reason the healthcare professional 18 is unable to view the evaluation in real-time, the patient data can be collected and stored on an electronic storage device 50.

It should be noted, that the patient data is also typically collected and stored when a real-time evaluation occurs. As with the majority of medical procedures, a patient's data must be collected and stored to provide a record of injury and illness. A common scenario will be that if a patient's injury or illness is not traumatic and/or immediately life-threatening, it will be easier and more economical for the healthcare professional to evaluate the patient's EFA data at the healthcare professional's convenience.

The electronic storage device 30 for collecting and storing the patient data is selected from the group consisting of a computer, an external/stand-alone hard drive, a compact disc (CD) recorder, a digital video disc (DVD) recorder, an optical media recorder, or a hard disc recorder.

Regardless of whether the healthcare professional 18 analyzes the patient data in real-time or at a convenient later time, the healthcare professional 18 will determine the appropriate treatment 32 and convey this information to the patient 20 himself or to the medical assistant 26 who is operating the EPA at the remote location with the patient. Obviously, if the patient is in need of immediate, emergency medical treatment, the appropriate steps will be taken by the healthcare professional 18 and/or the medical assistant 26.

Once the medical evaluation is complete, if the healthcare professional 18 is a member of the HP 10, the HP 10 will provide a bill for services provided to the patient or the patient's insurance company. The bill for services 34 comprises: analyzing the patient data, issuing a report for medical services or treatments that are recommended, patient data management (including collection and storage of the data), and medical supplies utilized during the patient evaluation.

When the healthcare professional 18 is a member of the HP 10, the membership contract 14 is designed to incorporate the following four principles:

Principle #1 The healthcare professional 18 has a unique specialty, expertise and/or equipment, and desires to promote those services worldwide.

Principle #2 The HP 10 agrees to provide the healthcare professional member with all the necessary equipment, training, support and expertise necessary to carry out the evaluation of patients.

Principle #3 The healthcare professional member agrees to abide by the membership contract, and to maintain all the necessary expertise to perform the evaluations, and

Principle #4 The membership contract does not violate franchise or healthcare laws and establishes only a member relationship with the healthcare professional via the HP 10.

Principle #5 The healthcare professional can perform the necessary baseline tests and post-loss tests to determine if an individual who has filed a workers-compensation claim compliant with a legitimate work-related injury.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A system and method for a healthcare provider that employees or contracts with a healthcare professional who utilizes a diagnostic unit that functions in combination with a computer operating proprietary software to perform injury assessment comprising baseline testing and comparison to post-loss testing, wherein the injury assessment is selected from the group consisting of electromyography (EMG), range-of-motion (ROM) and functional capacity assessment (FCA).

2. The system and method as specified in claim 1 wherein said diagnostic unit is comprised of a proprietary electrodiagnostic functional assessment unit.

3. The system and method as specified in claim 1 wherein said baseline testing is created for and performed on an individual in a specific employment position.

4. The system and method as specified in claim 3 wherein the individual in a specific employment position is an existing employee.

5. The system and method as specified in claim 3 wherein the individual in a specific employment position is a newly-hired employee.

6. The system and method as specified in claim 1 wherein said post-loss testing on an individual comprises the same test(s) that were performed for said baseline testing.

7. A system and method for a healthcare provider, wherein said method comprises the following steps:
1) select a specific type of employment,
2) create a series of tests for the specific type of employment wherein the tests consist of electromyography (EMG), range-of-motion (ROM) and function capacity assessment (FCA),
3) select an individual who is employed in the specific type of employment, wherein the individual is an existing employee or a newly-hired employee,
4) perform the series of tests on the individual, creating baseline test data,
5) store the created baseline test data,
6) perform a second series of the EMG, ROM and FCA tests on the individual after the individual has experienced a work-related injury, creating post-loss test data, and
7) compare and analyze the baseline test data with the post-loss test data to determine if a change in condition has occurred and the individual's injury is legitimately work related.

8. The system and method as specified in claim 7 wherein said baseline tests and said post-loss tests are performed by said healthcare provider.

9. The system and method as specified in claim 7 wherein all individuals in an employment scenario are tested to avoid discrimination.

10. The system and method as specified in claim 7 wherein said baseline test data is only read, analyzed and compared to said post-loss data, after an individual experiences a work-related injury.

11. The system and method as specified in claim 7 wherein said baseline test data is only read, analyzed and compared to said post-loss data, after an individual experiences a non-work related injury.

12. The system and method as specified in claim 7 wherein baseline test data that is read, analyzed and compared to said post-loss data is limited to said baseline data pertaining to the specific area of the individual's body where he/she experienced an injury.

13. A system and method for a healthcare provider that employs or contracts with a healthcare professional who utilizes a diagnostic unit that functions in combination with a computer operating software to perform injury assessment, wherein said method comprises the following steps:
1) select a specific type of employment,
2) create an electromyography (EMG) test for a specific type of employment,
3) create a range-of-motion (ROM) test for a specific type of employment,
4) create a functional capacity assessment (FCA) test for a specific type of employment,
5) utilize the EMG, ROM and FCA test results to create baseline data,
6) select an individual who is employed in the specific type of employment, wherein the individual is an existing employee or a newly-hired employee,
7) perform the EMG, ROM and FCA tests on the individual to create baseline data of the individual,
8) store the baseline data,
9) perform a second series of the EMG, ROM and FCA tests on the individual after the individual has experienced a work-related injury, creating post-loss test data, and
10) compare and analyze the baseline test data with the post-loss test data to determine if a change in condition has occurred and the individual's injury is legitimately work related.

14. The system and method as specified in claim 13 wherein said baseline tests and said post-loss tests are performed by said healthcare provider.

15. The system and method as specified in claim 13 wherein all individuals in an employment scenario are tested to avoid discrimination.

16. The system and method as specified in claim 13 wherein said test identifies non-work related injuries.

17. The system and method as specified in claim 13 wherein said baseline data is stored electronically.

18. The system and method as specified in claim 13 wherein said baseline test data is only read, analyzed and compared to said post-loss data, after an individual experiences an injury.

19. The system and method as specified in claim 13 wherein said baseline test data that is read, analyzed and compared to said post-loss data is limited to said baseline data pertaining to the specific area of the individual's body where he/she experienced an injury.

20. The system and method as specified in claim 13 wherein if there is a legitimate work-related injury, said healthcare provider recommends site-specific treatment based on the particular injury.
